(19) United States
(12) Patent Application Publication
(10) Pub. No.: US 2011/0003932 A1
(43) Pub. Date: Jan. 6, 2011

(54) FUNCTIONALIZED HIGH VINYL DIENE RUBBERS

(75) Inventors: Norbert Steinhauser, Monheim (DE); Thomas Gross, Wulfrath (DE); Alex Lucassen, Dormagen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/676,640

(22) PCT Filed: Sep. 4, 2008
(86) PCT No.: PCT/EP2008/061665

§ 371 Date: Sep. 20, 2010

(30) Foreign Application Priority Data
Sep. 15, 2007 (DE) 10 2007 044 175.6

(51) Int. Cl. C08L 9/00

(52) U.S. Cl. 524/571; 524/612

(57) ABSTRACT

The present invention relates to functionalized high-vinyl-content diene rubbers, to the preparation of rubber mixtures which comprise functionalized high-vinyl-content diene rubbers, and to the use thereof for the production of rubber vulcanizates which serve in particular for the production of highly reinforced rubber mouldings, particularly preferably for the production of tyres, where these have particularly low rolling resistance, and particularly high wet skid resistance and abrasion resistance.

The present invention relates to rubber mixtures, comprising functionalized high-vinyl-content diene rubbers, to the preparation of such rubber mixtures and to the use thereof for the production of rubber vulcanizates which serve in particular for the production of highly reinforced rubber mouldings, particularly preferably for the production of tyres, where these have particularly low rolling resistance, and particularly high wet skid resistance and abrasion resistance.

An important property desired in tyres is good adhesion to a dry or wet surface. It is very difficult here to improve the skid resistance of a tyre without at the same time increasing the rolling resistance and the abrasion. A low rolling resistance is important for low fuel consumption, and high abrasion resistance is the decisive factor for long lifetime of the tyre.

Wet skid resistance, rolling resistance and abrasion resistance of a tyre are mainly dependent on the dynamic-mechanical properties of the rubbers used to construct the tyre. To lower rolling resistance, rubbers with high rebound resilience are used for the tyre tread. On the other hand, rubbers with a high damping factor are advantageous for improving wet skid resistance. In order to find a compromise between these opposing dynamic-mechanical properties, mixtures composed of various rubbers are used in the tread. Mixtures usually used are composed of one or more rubbers with relatively high glass transition temperature, e.g. styrene-butadiene rubber, and of one or more rubbers with relatively low glass transition temperature, e.g. polybutadiene with low vinyl content.

Anionically polymerized solution rubbers containing double bonds, e.g. solution polybutadiene and solution styrene-butadiene rubbers, have advantages over corresponding emulsion rubbers for the production of low-rolling-resistance tyre treads. The advantages lie inter alia in the controllability of vinyl content and the attendant glass transition temperature and the extent of molecular branching.

Particular advantages result from this in practical applications in relation to wet skid resistance and rolling resistance of the tyre. For example, U.S. Pat. No. 5,227,425 describes the production of tyre treads from a solution styrene-butadiene rubber and silica. For further improvement of properties, numerous methods of end-group modification have been developed, as described in EP-A 334 042 using dimethylaminopropylacrylamide, and as described in EP-A 447 066 using silyl ethers.

However, by virtue of the high molecular weight of the rubbers, the proportion by weight of the end groups is low, and these can therefore have only little effect on the interaction between filler and rubber molecule. EP-A 1 000 971 discloses relatively highly functionalized copolymers which contain carboxy groups and are composed of vinylaromatics and of dienes, with up to 60% content of 1,2-bonded diene (vinyl content). Copolymers composed of diene and of functionalized vinylaromatic monomers are described in US 2005/0 256 284 A1. The disadvantage of the said copolymers lies in the complicated synthesis of the functionalized vinylaromatic monomers and in the severe restriction in the selection of the functional groups, since the only functional groups that can be used are those which during the anionic polymerization reaction do not undergo any reaction with the initiator. In particular, it is impossible to use functional groups which have hydrogen atoms which are capable of fowling hydrogen bonds and are therefore capable of forming particularly advantageous interactions with the silica filler in the rubber mixture.

German Offenlegungschrift 2 653 144 describes a process for the preparation of solution diene rubbers which contain hydroxy groups and carboxy groups and whose content of 1,2-bonded butadiene (vinyl content) is from 30 to 60%. Rubber mixtures composed of diene rubbers containing hydroxy groups and carboxy groups and whose glass transition temperature is from −110 to −50° C. are described in DE 19 920 894 A1 and DE 19 920 788 A1. These exclude diene rubbers having relatively high vinyl content or having a glass transition temperature >−50° C.

U.S. Pat. No. 5,534,592, EP 796 893 A1 and EP 903 373 A1 describe the use of non-functionalized high-vinyl-content diene rubbers whose vinyl content is 65% in tyre applications. By way of example, substitution of solution styrene-butadiene rubber by high-vinyl-content diene rubber led in EP 796 893 A1 to slightly improved wet skid resistance with the same rolling resistance and improved abrasion resistance.

It was therefore an object to provide rubber mixtures which do not have the disadvantages of the prior art.

It has now been found that the use of functionalized high-vinyl-content diene rubbers whose vinyl content is >60% can produce tyres with reduced rolling resistance, with high abrasion resistance, and with high wet skid resistance.

The present invention therefore provides rubber mixtures composed of at least one rubber and of from 10 to 500 parts by weight of filler, based on 100 parts by weight of rubber, where the rubber has been prepared via polymerization of one or more dienes in solution and subsequent introduction of functional groups, the said rubber has from 0.02 to 3% by weight, preferably from 0.05 to 2% by weight, of bonded functional groups or salts thereof, and the content of 1,2-bonded dienes (vinyl content) is from 60 to 95% by weight, preferably from 62 to 85% by weight, based in each case on the solution rubber used.

The glass transition temperature of the inventive rubbers is moreover preferably >−50° C.

According to the invention, dienes serving for the polymerization reaction comprise 1,3-butadiene, isoprene, 1,3-pentadiene, 2,3-dimethylbutadiene, 1-phenyl-1,3-butadiene and/or 1,3-hexadiene. 1,3-Butadiene and/or isoprene are particularly preferably used, and 1,3-butadiene is very particularly preferably used.

The rubbers which are based on dienes and which are to be used according to the invention in the rubber mixtures and whose content of bonded functional groups is from 0.02 to 3% by weight preferably have average (number-average) molar masses of from 50 000 to 2 000 000 g/mol, preferably from 100 000 to 1 000 000 g/mol, and glass transition temperatures of from −50° C. to −5° C., with preference from −45° C. to −10° C., and Mooney viscosities ML 1+4 (100° C.) of from 10 to 200, preferably from 30 to 150.

The inventive rubbers can bear, as functional groups and/or salts thereof, groups such as carboxy, hydroxy, amine, carboxylic ester, carboxamide or sulphonic acid groups. Carboxy or hydroxy groups are preferred. Preferred salts are alkali metal carboxylates, alkaline earth metal carboxylates, zinc carboxylates and ammonium carboxylates, and alkali metal sulphonates, alkaline earth metal sulphonates, zinc sulphonates and ammonium sulphonates.

The inventive rubbers are preferably prepared here via polymerization of dienes in solution and subsequent introduction of functional groups.

The invention moreover provides a process for the preparation of the inventive rubber mixtures in that the dienes are polymerized in solution to give rubber, and the functional groups or salts thereof are then introduced into the solution rubber, where solvent is removed using hot water and/or steam at temperatures of from 50 to 200° C., if appropriate in vacuo, and then filler and, if appropriate, process oil is added.

In another embodiment of the inventive process, the dienes are polymerized in solution to give rubber, and then the functional groups or salts thereof are introduced into the solution rubber, and then the solvent-containing rubber is mixed with process oil, and the solvent here is removed during or after the mixing procedure with hot water and/or steam at temperatures of from 50 to 200° C., if appropriate in vacuo, and then filler is added.

In another embodiment of the invention, the filler is added with the process oil after introduction of the functional groups.

The inventive rubbers for the inventive rubber mixtures are preferably prepared via anionic solution polymerization or via polymerization by means of coordination catalysts. Coordination catalysts in this context are Ziegler-Natta catalysts or monometallic catalyst systems. Preferred coordination catalysts are those based on Ni, Co, Ti, Nd, V, Cr or Fe.

Initiators for the anionic solution polymerization reaction are those based on alkali metal or on alkaline earth metal, e.g. n-butyllithium. The known control agents for the microstructure of the polymer can also be used, such as tert.-butoxyethoxyethane. These solution polymerization reactions are known and are described by way of example in I. Franta Elastomers and Rubber Compounding Materials; Elsevier 1989, pages 113-131, in Houben-Weyl, Methoden der Organischen Chemie [Methods of Organic Chemistry], Thieme Verlag, Stuttgart, 1961, Volume XIV/1 pages 645 to 673 or in Volume E 20 (1987), pages 114 to 134 and pages 134 to 153 and in Comprehensive Polymer Science, Vol. 4, Part II (Pergamon Press Ltd., Oxford 1989), pages 53-108.

Preferred solvents used here are inert aprotic solvents, e.g. paraffinic hydrocarbons, such as isomeric pentanes, hexanes, heptanes, octanes, decanes, cyclopentane, cyclohexane, methylcyclohexane, ethylcyclohexane or 1,4-dimethylcyclohexane, or aromatic hydrocarbons, such as benzene, toluene, ethylbenzene, xylene, diethylbenzene or propylbenzene. These solvents can be used individually or in combination. Preference is given to cyclohexane and n-hexane. A blend with polar solvents is also possible.

The amount of solvent in the inventive process usually amounts to from 1000 to 100 g, preferably from 700 to 200 g, based on 100 g of the entire amount of monomer used. However, it is also possible to polymerize the monomers used in the absence of solvents.

The polymerization temperature can vary within a wide range and is generally in the range from 0° C. to 200° C., preferably from 40° C. to 130° C. The reaction time likewise varies widely from a few minutes to a few hours. The polymerization process is usually carried out within a period of from about 30 minutes to 8 hours, preferably from 1 to 4 hours. It can be carried out either at atmospheric pressure or else at an elevated pressure (from 1 to 10 bar).

The functional groups here are introduced according to known processes in single- or multistage reactions via addition reactions with corresponding functionalizing reagents to the double bonds of the rubber or via abstraction of allylic hydrogen atoms and subsequent reaction with functionalizing reagents.

The carboxy groups can be introduced in various ways into the rubber, an example being compounds such as CO₂ which provide carboxy groups are added to the metallated solution rubbers, or use of the transition-metal-catalyzed hydrocarboxylation reaction known in the prior art, or treatment of the rubber with compounds containing carboxy groups, for example mercaptans containing carboxy groups.

Carboxy group content can be determined by known methods, e.g. titration of the free acid, spectroscopy or elemental analysis.

The introduction of the carboxy groups into the rubber preferably takes place after polymerization of the monomers used, in solution via reaction of the resultant polymers, if appropriate in the presence of free-radical initiators, with carboxymercaptans of the formula

HS—R¹—COOX or (HS—R¹—COO)₂X

in which
R¹ is a linear, branched or cyclic C₁-C₃₆-alkylene group or C₁-C₃₆-alkenylene group, each of which, if appropriate, can have up to three further carboxy groups as substituents, or can have interruption by nitrogen atoms, by oxygen atoms or by sulphur atoms, or is an aryl group, and
X is hydrogen or a metal ion, e.g. Li, Na, K, Mg, Zn, Ca or an ammonium ion which, if appropriate, has C₁-C₃₆-alkyl groups, C₁-C₃₆-alkenyl groups, cycloalkyl groups or aryl groups as substituents.

Preferred carboxymercaptans are thioglycolic acid, 2-mercaptopropionic acid (thiolactic acid), 3-mercaptopropionic acid, 4-mercaptobutyric acid, mercaptohexanoic acid, mercaptooctanoic acid, mercaptodecanoic acid, mercaptoundecanoic acid, mercaptododecanoic acid, mercaptooctadecanoic acid, 2-mercaptosuccinic acid, and the alkali metal and alkaline earth metal, zinc or ammonium salts thereof. It is particularly preferable to use 2- and 3-mercaptopropionic acid, mercaptobutyric acid and 2-mercaptosuccinic acid, and the lithium, sodium, potassium, magnesium, calcium, zinc or ammonium salts thereof. Very particular preference is given to 3-mercaptopropionic acid, and the lithium, sodium, potassium, magnesium, calcium, zinc or ammonium, ethylammonium, diethylammonium, triethylammonium, stearylammonium and cyclohexylammonium salts thereof.

The reaction of the carboxymercaptans with the solution rubber is generally carried out in a solvent, for example hydrocarbons, such as pentane, hexane, cyclohexane, benzene and/or toluene, at temperatures of from 40 to 150° C., in the presence of free-radical initiators, e.g. peroxides, in particular acyl peroxides, such as dilauroyl peroxide and dibenzoyl peroxide, and ketal peroxides, such as 1,1-bis(tert-butyl-peroxy)-3,3,5-trimethylcyclohexane, or else azo initiators, such as azobisisobutyronitrile, or of benzopinacol silyl ethers, or in the presence of photoinitiators and visible or UV light.

The amount of carboxymercaptans to be used depends on the desired content of bonded carboxy groups or salts thereof in the solution rubber to be used in the rubber mixtures.

The carboxylic salts can also be prepared after the introduction of the carboxylic acid groups into the rubber, via neutralization thereof.

The hydroxy groups can, for example, be introduced into the rubber by epoxidizing the solution rubber and then ring-opening the epoxy groups, hydroborating the solution rubber and then treating it with alkaline hydrogen peroxide solution, or treating the rubber with compounds containing hydroxy groups, for example mercaptans containing hydroxy groups.

The introduction of the hydroxy groups into the rubber preferably takes place after polymerization of the monomers used, in solution via reaction of the resultant polymers, if appropriate in the presence of free-radical initiators, with hydroxymercaptans of the formula

HS—R²—OH

in which
R² is a linear, branched or cyclic C₁-C₃₆-alkylene group or C₁-C₃₆-alkenylene group, each of which, if appropriate, can have up to three further hydroxy groups as substituents, or can have interruption by nitrogen atoms, by oxygen atoms or by sulphur atoms, or can have aryl substituents, or is an aryl group.

Preferred hydroxymercaptans are thioethanol, 2-mercaptopropanol, 3-mercaptopropanol, 4-mercaptobutanol, 6-mercaptohexanol, mercaptooctanol, mercaptodecanol, mercaptododecanol, mercaptohexadecanol, mercaptooctadecanol. Particular preference is given to mercaptoethanol, 2- and 3-mercaptopropanol and mercaptobutanol.

The reaction of the hydroxymercaptans with the solution rubber is generally carried out in a solvent, the method for this being the same as described for the carboxymercaptans.

Carboxylic ester groups and amino groups can be introduced in corresponding fashion from mercaptocarboxylic esters and mercaptoamines of the general formula

HS—R³—COOR⁴, HS—R³—NR⁵R⁶

in which
R³ is a linear, branched or cyclic C₁-C₃₆-alkylene group or C₁-C₃₆-alkenylene group, each of which, if appropriate, can have up to three further carboxylic ester groups or amino groups as substituents, or can have interruption by nitrogen atoms, by oxygen atoms or by sulphur atoms, or is an aryl group, and
R⁴ is a linear, branched or cyclic C₁-C₃₆-alkyl group or C₁-C₃₆-alkenyl group which, if appropriate, can have interruption by nitrogen atoms, by oxygen atoms or by sulphur atoms, or is a phenyl group which can have up to 5 alkyl substituents or aromatic substituents,
R⁵ and R⁶ are hydrogen or a linear, branched or cyclic C₁-C₃₆-alkyl group or C₁-C₃₆-alkenyl group which, if appropriate, can have interruption by nitrogen atoms, by oxygen atoms or by sulphur atoms, or is a phenyl group which can have up to 5 alkyl substituents or aromatic substituents.

Fillers that can be used for the inventive rubber mixtures are any of the fillers known and used in the rubber industry. These encompass not only active fillers but also inert fillers.

Mention may be made by way of example of:
fine-particle silicas, prepared, for example, via precipitation of solutions of silicates, or flame hydrolysis of silicon halides with specific surface areas of from 5 to 1000 m²/g, preferably from 20 to 400 m²/g (BET surface area) and with primary particle sizes of from 10 to 400 nm. The silicas can also, if appropriate, be present in the form of mixed oxides with other metal oxides, such as Al, Mg, Ca, Ba, Zn, Zr, or Ti oxides;
synthetic silicates, such as aluminium silicate, alkaline earth metal silicate, such as magnesium silicate or calcium silicate, with BET surface areas of from 20 to 400 m²/g and primary particle diameters of from 10 to 400 nm;
natural silicates, such as kaolin and other naturally occurring types of silica;
glass fibres and glass-fibre products (mats, strands) or glass microbeads;
metal oxides, such as zinc oxide, calcium oxide, magnesium oxide, or aluminium oxide;
metal carbonates, such as magnesium carbonate, calcium carbonate, or zinc carbonate;
metal hydroxides, such as aluminium hydroxide or magnesium hydroxide;
carbon blacks: the carbon blacks to be used here are carbon blacks prepared by the flame-black process, channel-black process, furnace-black process, gas-black process, thermal-black process, acetylene-black process or arc process, their BET surface areas being from 9 to 200 m²/g, e.g. SAF, ISAF-LS, ISAF-HM, ISAF-LM, ISAF-HS, CF, SCF, HAF-LS, HAF, HAF-HS, FF-HS, SRF, XCF, FEF-LS, FEF, FEF-HS, GPF-HS, GPF, APF, SRF-LS, SRF-LM, SRF-HS, SRF-HM and MT carbon blacks, according to ASTM N110, N219, N220, N231, N234, N242, N294, N326, N327, N330, N332, N339, N347, N351, N356, N358, N375, N472, N539, N550, N568, N650, N660, N754, N762, N765, N774, N787 and N990 carbon blacks.
rubber gels, in particular those based on polybutadiene, butadiene-styrene copolymers, butadiene-acrylonitrile copolymers and polychloroprene.

Fillers preferably used are fine-particle silicas and/or carbon blacks.

The fillers mentioned can be used alone or in a mixture. In one particularly preferred embodiment, the rubber mixtures comprise, as fillers, a mixture composed of pale-coloured fillers, such as fine-particle silicas and carbon blacks, where the mixing ratio of pale-coloured fillers to carbon blacks is from 0.05 to 20, preferably from 0.1 to 15.

The amounts used here of the fillers are in the range from 10 to 500 parts by weight, based on 100 parts by weight of rubber. From 20 to 200 parts by weight are preferably used.

The inventive rubber mixtures can comprise not only the functionalized solution rubbers mentioned but also other rubbers, such as natural rubber, or else synthetic rubbers. The amount of these is usually in the range from 0.5 to 85% by weight, preferably from 10 to 70% by weight, based on the total amount of rubber in the rubber mixture. The amount of additional rubbers added again depends on the respective intended use of the inventive rubber mixtures.

Examples of additional rubbers are natural rubber and synthetic rubber.

Synthetic rubbers known from the literature are listed here by way of example. They encompass inter alia
BR=polybutadiene
ABR=butadiene/C₁-C₄-alkyl acrylate copolymers
CR=polychloroprene
IR=polyisoprene
SBR=styrene-butadiene copolymers with styrene contents of from 1 to 60% by weight, preferably from 20 to 50% by weight
IIR=isobutylene-isoprene copolymers
NBR=butadiene-acrylonitrile copolymers with acrylonitrile contents of from 5 to 60% by weight, preferably from 10 to 40% by weight
HNBR=partially hydrogenated or completely hydrogenated NBR rubber
EPDM=ethylene-propylene-diene terpolymers
   and mixtures of these rubbers. For the production of motor vehicle tyres, materials of particular interest are natural rubber, emulsion SBR and solution SBR whose glass transition temperature is above −50° C., polybutadiene rubber with high cis content (>90%) which has been prepared using catalysts based on Ni, Co, Ti or Nd, and polybutadiene rubber with vinyl content of up to 80%, and mixtures thereof.

The inventive rubber mixtures can, of course, also comprise other rubber auxiliaries, which by way of example serve for the crosslinking of the rubber mixtures, or which improve the physical properties of the vulcanizates produced from the inventive rubber mixtures, for the specific application thereof.

Particular crosslinking agents used are sulphur or sulphur-donor compounds. The inventive rubber mixtures can moreover, as mentioned, comprise other auxiliaries, such as the known reaction accelerators, antioxidants, heat stabilizers, light stabilizers, antiozonants, processing aids, plasticizers, tackifiers, blowing agents, dyes, pigments, waxes, extenders, organic acids, retarders, metal oxides and activators.

As mentioned above, the inventive rubber mixtures can receive mixtures of additional rubbers, alongside the functionalized rubber. The amount of these is usually in the range from 0.5 to 85% by weight, preferably from 10 to 70% by weight, based on the entire amount of rubber in the rubber mixture. The amount of additional rubbers added again depends on the respective intended use of the inventive rubber mixtures.

The inventive rubber mixtures can by way of example be prepared via blending of the functionalized rubbers with filler and with the other mixture constituents in or on suitable mixing apparatuses, for example in kneaders, on mills, or in extruders.

In a further embodiment, the inventive rubber mixtures can be prepared by first polymerizing, in solution, the monomers mentioned, introducing the functional groups into the solution rubber and, after completion of the polymerization reaction and introduction of the functional groups, mixing the solution rubber present in the corresponding solvent with antioxidants and, if appropriate process oil, filler, further rubbers, and further rubber auxiliaries, in the appropriate amounts, and, during or after the mixing procedure, removing the solvent with hot water and/or steam at temperatures of from 50° C. to 200° C., if appropriate in vacuo.

The present invention further provides for use of the inventive rubber mixtures for the production of vulcanizates, which serve in turn for the production of highly reinforced rubber mouldings, in particular for the production of tyres.

The examples below serve to illustrate the invention, but without any limiting effect here.

### EXAMPLES

### Example 1

### Synthesis of High-Vinyl-Content Polybutadiene

8.5 kg of hexane, 171 mmol of tert-butoxyethoxyethane, 8 mmol of butyllithium and 1.5 kg (27.73 mol) of 1,3-butadiene were charged to an inertized 20 L reactor, and the contents were heated to 80° C. The mixture was polymerized at 80° C. for 1 h, with stirring. The rubber solution was then discharged and stabilized by adding 3 g of Irganox 1520® (2,4-bis(octylthiomethyl)-6-methylphenol from Ciba), and the solvent was removed by stripping with steam. The rubber crumbs were dried in vacuo at 65° C.

Mooney viscosity (ML 1+4, 100° C.): 80; vinyl content (by IR spectroscopy): 82%; glass transition temperature (DSC): −25° C.

### Examples 2-4

### Synthesis of COOH-Functionalized High-Vinyl-Content Polybutadiene

### Example 2

8.5 kg of hexane, 171 mmol of tert-butoxyethoxyethane, 10 mmol of butyllithium and 1.5 kg (27.73 mol) of 1,3-butadiene were charged to an inertized 20 L reactor, and the contents were heated to 80° C. The mixture was polymerized at 80° C. for 1 h, with stirring. 21 g (0.2 mol) of 3-mercaptopropionic acid and 0.75 g of dilauroyl peroxide were then added, and the reactor contents were heated to 90° C. for 90 min. The rubber solution was then discharged and stabilized by adding 3 g of Irganox 1520®, and the solvent was removed by stripping with steam. The rubber crumbs were dried in vacuo at 65° C.

Mooney viscosity (ML 1+4, 100° C.): 76; vinyl content (by IR spectroscopy): 81%; glass transition temperature (DSC): −24° C.

### Example 3

The procedure was as in Example 2.

Mooney viscosity (ML 1+4, 100° C.): 85; vinyl content (by IR spectroscopy): 81%; glass transition temperature (DSC): −25° C.

### Example 4

The procedure was as in Example 2. The polymerization reaction used 9.5 mmol of butyllithium.

Mooney viscosity (ML 1+4, 100° C.): 111; vinyl content (by IR spectroscopy): 81%; glass transition temperature (DSC): −22° C.

### Example 5

### Rubber Mixtures and Vulcanizate Properties

Rubber mixtures were prepared which comprise the functionalized high-vinyl-content polybutadienes of Examples 2-4 and, as comparison, the non-functionalized high-vinyl-content polybutadiene from Example 1 and a commercial styrene-butadiene copolymer (VSL 5025-0 HM from Lanxess, 50% vinyl content, 25% styrene content, Mooney viscosity 65, glass transition temperature (DSC) −22° C.). The mixture constituents are listed in Table 1. The mixtures (without sulphur and accelerator) were prepared in a 1.5 L kneader. The mixture constituents sulphur and accelerator were then admixed on a mill at 40° C.

TABLE 1
Mixture constituents (data in phr)

| | Comparative | Comparative | Inventive | Inventive | Inventive |
|---|---|---|---|---|---|
| | Example 5A | Example 5B | Example 5C | Example 5D | Example 5E |
| Styrene-butadiene rubber (VSL 5025-0 HM, Lanxess) | 36.85 | 0 | 0 | 0 | 0 |
| High-vinyl-content polybutadiene according to Example 1 | 0 | 36.85 | 0 | 0 | 0 |
| Functionalized high-vinyl-content polybutadiene according to | 0 | 0 | 36.85 | 0 | 0 |
| Functionalized high-vinyl-content polybutadiene according to | 0 | 0 | 0 | 36.85 | 0 |
| Functionalized high-vinyl-content polybutadiene according to | 0 | 0 | 0 | 0 | 36.85 |
| Natural rubber (TSR 5 Defo 100) | 21.05 | 21.05 | 21.05 | 21.05 | 21.05 |
| High-cis polybutadiene (Buna CB 25, Lanxess) | 42.1 | 42.1 | 42.1 | 42.1 | 42.1 |
| Carbon black (Corax N 234) | 6.3 | 6.3 | 6.3 | 6.3 | 6.3 |
| Silica (Ultrasil 7000 GR) | 84.2 | 84.2 | 84.2 | 84.2 | 84.2 |
| Stabilizer 6PPD (Vulkanox 4020) | 1.6 | 1.6 | 1.6 | 1.6 | 1.6 |
| Stabilizer TMQ (Vulkanox HS) | 1.6 | 1.6 | 1.6 | 1.6 | 1.6 |
| Stearic acid (Edenor C 18 98-100) | 2.1 | 2.1 | 2.1 | 2.1 | 2.1 |
| Zinc soap (Aktiplast ST) | 2.1 | 2.1 | 2.1 | 2.1 | 2.1 |
| TDAE oil (Vivatec 500) | 39.5 | 39.5 | 39.5 | 39.5 | 39.5 |
| Diphenylguanidine (Vulkacit D/C) | 2.1 | 2.1 | 2.1 | 2.1 | 2.1 |
| Sulphenamide (Vulkacit CZ/C) | 1.9 | 1.9 | 1.9 | 1.9 | 1.9 |
| Sulphur | 1.6 | 1.6 | 1.6 | 1.6 | 1.6 |
| Silane (Si 69) | 6.7 | 6.7 | 6.7 | 6.7 | 6.7 |
| ZnO | 3.7 | 3.7 | 3.7 | 3.7 | 3.7 |

The mixtures according to Table 1 were vulcanized at 160° C. for 20 minutes.
The properties of the vulcanizates are listed in Table 2.

TABLE 2
Vulcanizate properties

| | Comparative | Comparative | Inventive | Inventive | Inventive |
|---|---|---|---|---|---|
| | Example 5A | Example 5B | Example 5C | Example 5D | Example 5E |
| Rebound resilience at 23° C. [%] | 40 | 43 | 46 | 45.5 | 47 |
| Rebound resilience at 70° C. [%] | 54 | 57 | 63 | 63.5 | 65 |
| tan δ maximum (MTS amplitude sweep at 10 Hz) | 0.277 | 0.238 | 0.207 | 0.203 | 0.203 |
| tan δ at −20° C. (dynamic damping at 10 Hz) | 0.278 | 0.436 | 0.507 | 0.501 | 0.507 |
| tan δ at 0° C. (dynamic damping at 10 Hz) | 0.189 | 0.178 | 0.268 | 0.290 | 0.267 |
| tan δ at 60° C. (dynamic damping at 10 Hz) | 0.119 | 0.102 | 0.083 | 0.078 | 0.077 |
| tan δ at 80° C. (dynamic damping at 10 Hz) | 0.114 | 0.097 | 0.079 | 0.076 | 0.074 |
| Abrasion (DIN 53516) [mm³] | 82 | 71 | 56 | 54 | 58 |

Low rolling resistance is needed for tyre applications, and is present if the vulcanizate has a high value for rebound resilience at 70° C. and low tan δ values for dynamic damping at high temperatures (60° C. and 80° C.) and a low tan δ maximum in the amplitude sweep. As can be seen from Table 2, the vulcanizates of the inventive examples feature high rebound resilience at 70° C. and low tan δ values for dynamic damping at 60° C. and 80° C. and a low tan δ maximum in the amplitude sweep.

Tyre applications also require high wet skid resistance and this is present if the vulcanizate has high tan δ values for dynamic damping at low temperatures (−20° C. and 0° C.). As can be seen from Table 2, the vulcanizates of the inventive examples feature high tan δ values for dynamic damping at −20° C. and 0° C.

Tyre applications moreover need high abrasion resistance. As can be seen from Table 2, the vulcanizates of the inventive examples feature low DIN abrasion.

What is claimed is:

1. Rubber mixtures composed of at least one rubber and of from 10 to 500 parts by weight of filler, based on 100 parts by weight of rubber, where the rubber has been prepared via polymerization of one or more dienes in solution and subsequent introduction of functional groups, the said rubber has from 0.02 to 3% by weight of bonded functional groups or salts thereof, and the content of 1,2-bonded dienes (vinyl content) is from 60 to 95% by weight, based in each case on the solution rubber used.

2. Rubber mixtures according to claim 1, characterized in that the functional groups are carboxy groups or hydroxy groups.

3. Rubber mixtures according to claim 1, characterized in that the diene is 1,3-butadiene.

4. Rubber mixtures according to claim 1, characterized in that the rubber mixtures contain a mixture of different fillers.

5. Process for the preparation of the rubber mixtures according to claim 1, characterized in that the dienes are polymerized in solution to give rubber, and the functional groups or salts thereof are then introduced into the solution rubber, where solvent is removed using hot water and/or steam at temperatures of from 50 to 200° C., if appropriate in vacuo, and then filler and, if appropriate, process oil is added.

6. Use of the rubber mixtures according to claim 1 for the production of highly reinforced rubber mouldings.

7. Use of the rubber mixtures according to claim 1 for the production of tyres.
